(19) United States
(12) Patent Application Publication
(10) Pub. No.: US 2002/0020493 A1
(43) Pub. Date: Feb. 21, 2002

(54) Method of coupling members

(75) Inventor: Jun Ichihara, Kyoto (JP)

Correspondence Address: MORGAN, LEWIS & BOCKIUS, 1800 M STREET NW, WASHINGTON, DC, 20036-5869, US

(73) Assignee: ROHM CO., LTD.

(21) Appl. No.: 09/983,923

(22) Filed: Oct. 26, 2001

Related U.S. Application Data
(62) Division of application No. 09/395,164, filed on Sep. 14, 1999.

(30) Foreign Application Priority Data
Sep. 16, 1998 (JP) P. HEI. 10-261201

(51) Int. Cl. B32B 3/00

(52) U.S. Cl. 156/308.8; 428/57

(57) ABSTRACT

In order to provide a low-cost and high-reliable method of coupling a first member and a second member with each other, the method comprises the steps of: performing positioning between the first and second members and then bonding the first and second members to each other by a first adhesive bonding treatment to make short-time fixation possible; and bonding the first and second members to each other by a second adhesive bonding treatment requiring a longer fixation time than that required for the first adhesive bonding treatment.

### BACKGROUND OF THE INVENTION

1. Field of the Invention

The present invention relates to a method of coupling members and particularly to a technique of coupling two or more members required to be subjected to positioning, for example a method of coupling optical elements each other.

2. Description of the Related Art

A photo-coupler is known as a device in which two optical elements, such as a laser diode and an optical fiber, etc., are optically coupled with each other. In the casing that these optical elements are coupled with each other, a very small deviation causes a large optical error. Therefore accurate alignment is required. FIGS. 5A and 5B show an example of a background-art coupling method for producing such a photo-coupler.

This method relates to a method of producing a photo-coupler by mounting a laser diode to a casing including a lens, and optically coupling the laser diode and the lens. As shown in FIG. 5A, first, a metal casing 2 equipped with an optical fiber (not shown) and a laser diode 4 having a metal flange 4b are prepared to produce a photo-coupler. The casing 2 and the laser diode 4 are disposed so that an end surface 2b of the casing 2 and an end surface 4c of the flange 4b of the laser diode 4 butt on each other.

In this state, the laser diode 4 is moved relative to the casing 2 both in Y directions in FIG. 5A and in directions perpendicular to the paper surface of FIG. 5A to perform positioning so as to make an optical axis 4a of the laser diode 4 coincide with an optical axis 2a of the casing 2.

In the state in which the optical axis 4a of the laser diode 4 coincides with the optical axis 2a of the casing 2, a cylindrical outer circumferential surface 4d of the flange 4b of the laser diode 4 is fixedly welded to the end surface 2b of the casing 2 by an YAG laser, or the like, as shown in FIG. 5B. Thus, the laser diode 4 is fixed to the casing 2.

FIGS. 6A and 6B show another background-art method for producing a photo-coupler. Also in this case, positioning is performed so as to make the optical axis 4a of the laser diode 4 coincide with the optical axis 2a of the casing 2 as shown in FIG. 6A.

The positioning is performed by screwing in/out a plurality of screws 6 screwed into the casing 2. By using the plurality of screws 6 as described above, the laser diode 4 can be fixed to the casing 2 simultaneously with the positioning. Further, as shown in FIG. 6B, a gap between the cylindrical outer circumferential surface 4d of the flange 4b of the laser diode 4 and a large-diameter inner circumferential surface 2c of the casing 2 receiving the flange 4b is filled with a heat-curable adhesive agent 8 and heated so that the laser diode 4 is fixed to the casing 2 more firmly.

FIGS. 7A and 7B show a further background-art method for producing a photo-coupler. Also in this case, positioning is performed so as to make the optical axis 4a of the laser diode 4 coincide with the optical axis 2a of the casing 2 as shown in FIG. 7A.

In the state in which the optical axis 4a of the laser diode 4 coincides with the optical axis 2a of the casing 2, as shown in FIG. 7B, an ultraviolet (UV)-curable adhesive agent 10 is applied to a corner between the end surface 2b of the casing 2 and the cylindrical outer circumferential surface 4d of the flange 4b of the laser diode 4 and irradiated with ultraviolet rays so that the laser diode 4 is fixed to the casing 2.

The aforementioned background-art methods for producing a photo-coupler, however, have the following problems.

In the method shown in FIGS. 5A and 5B, metal is melted when welding is performed. Accordingly, there is a possibility that the optical axis 2a of the casing 2 which had been made coincident with the optical axis 4a of the laser diode 4 may be displaced when molten metal is solidified. Further, an apparatus for performing welding is large-sized. And exclusive apparatus for welding is required. Accordingly, the cost for production becomes high.

In the method shown in FIGS. 6A and 6B, positioning must be performed by screwing in/out the plurality of screws 6. Accordingly, the work of positioning is complicated, so that the cost of production becomes high.

In the method shown in FIGS. 7A and 7B, since the ultraviolet-curable adhesive agent 10 is used, the adhesive agent 10 permeating the place where ultraviolet rays cannot irradiate such as a gap between the end surface 2b of the casing 2 and the end surface 4c of the flange 4b of the laser diode 4, or the like, is not cured. Accordingly, there is a fear that the uncured component of the adhesive agent 10 enters the inside of the casing 2 and deposit on a lens 4e of the laser diode 4, or the like. As a result, the reliability of the photo-coupler is reduced. Further, some type of adhesive agent 10 is softened by heat. Accordingly, there is a possibility that the optical axis 2a of the casing 2 which had been made coincident with the optical axis 4a of the laser diode 4 may be displaced due that a adhesive agent is softened or due to thermal expansion.

### SUMMARY OF THE INVENTION

It is therefore an object of the present invention to solve the aforementioned problems.

It is another object of the present invention to provide a low-cost and high-reliable coupling member method.

It is a further object of the present invention to provide a low-cost and high-reliable optical material, or the like.

In order to achieve the above objects, according to a first aspect of the present invention, there is provided a method of coupling a first member and a second member with each other, comprising the steps of: performing positioning between the first and second members and then bonding the first and second members to each other by a first adhesive bonding treatment to make short-time fixation possible; and

bonding the first and second members to each other by a second adhesive bonding treatment requiring a longer fixation time than that required for the first adhesive bonding treatment.

Accordingly, when the first and second members are quickly temporarily fixed to each other by the first adhesive bonding treatment after positioning between the first and second members, the first and second members can be prevented from being displaced from each other after the positioning. Then, the first and second members temporarily fixed to each other can be fixed to each other more firmly in a sufficient time by the second adhesive bonding treatment. Accordingly, coupling with little displacement and high strength can be performed by use of the adhesive bonding treatments which are easy to work. That is, low-cost and high-reliable coupling can be performed.

According to the second aspect of the present invention, in the member coupling method of the first aspect, wherein

the second adhesive agent has a lower curing rate than that of said first adhesive agent and

the positioning is performed after applying the first and second adhesive agents to first region and second regions on the first and/or second member respectively,

and the first and second bonding steps are performed successively.

Accordingly, when optimum adhesive agents are used in accordance with the purposes of the adhesive bonding treatments, the members can be bonded to each other more efficiently.

According to a third aspect of the present invention, in the member coupling method of the first or second aspect, the first adhesive bonding treatment is a treatment of curing an adhesive agent by light.

Accordingly, when the adhesive agent used in the first adhesive bonding treatment is applied in advance before the positioning, the first and second members can be temporarily fixed to each other more rapidly by radiation of light onto the applied adhesive agent after the positioning.

According to a fourth aspect of the present invention, in the member coupling method of any one of the first through third aspect, the second adhesive bonding treatment is a treatment of curing an adhesive agent by heat.

Accordingly, when the adhesive agent used in the second adhesive bonding treatment is applied in advance before the positioning, a firmer fixing force between the members can be obtained more easily by heating after the positioning and temporary fixation.

Further, since an adhesive agent can be applied in advance before the positioning, any place of the first and second members where the adhesive agent cannot be applied can be adhesively bonded after the positioning and temporary fixation. Further, the adhesive portion is not limited within a range where light can reach as in the case where the adhesive agent cures by light. Accordingly, the first and second members can be adhesively bonded to each other in any convenient place selected freely to fix the members to each other. Accordingly, a firmer fixing force between the members can be obtained.

According to a fifth aspect of the present invention, in the member coupling method of the fourth aspect, the second adhesive agent used in the second adhesive bonding treatment is an adhesive agent which is not fluid before heating and which is once fluidized and then cured by heating. Further clearance between the members to be bonded each other can be formed, considering the thermal expansion of the second adhesive agent. Accordingly, in the case where the adhesive agent is applied to the adhesive bonding portion in advance before the positioning, resistance caused by the adhesive agent at the time of the relative movement of the two members for positioning can be eliminated if a sufficient gap is kept between the two members in the adhesive bonding portion. Accordingly, the positioning can be performed easily compared with the case where a fluid adhesive agent is applied to the adhesive-bonding portion in advance.

According to a sixth aspect of the present invention, in the member coupling method of the fourth or fifth aspect, the first and second members are bonded to each other so that a predetermined space is formed; and the second adhesive agent used in the second adhesive bonding treatment is disposed between the space and the first adhesive agent so that the space is not invaded by an uncured component of the first adhesive agent used in the first adhesive bonding treatment.

Accordingly, even in the case where an uncured component remains in the first adhesive agent used in the first adhesive bonding treatment when the two members are temporarily fixed to each other by the first adhesive bonding treatment, the second adhesive agent used in the second adhesive bonding treatment, which is disposed in any suitable place and sufficiently cures in a long time, can prevent the uncured component from invading the aforementioned space. Accordingly, this is convenient to the case where it is undesirable that the uncured component invades the space.

According to a seventh aspect of the present invention, in the member coupling method of the sixth aspect, the second adhesive agent used in the second adhesive bonding treatment is an adhesive agent containing a component for curing the uncured component of the first adhesive agent used in the first adhesive bonding treatment.

Accordingly, even in the case where an uncured component remains in the adhesive agent used in the first adhesive bonding treatment when the two members are temporarily fixed to each other by the first adhesive bonding treatment, the uncured component can be cured in the second adhesive bonding treatment by the adhesive agent disposed in any suitable place and used in the second adhesive bonding treatment. Accordingly, this is more convenient to the case where it is undesirable that the uncured component invades the space.

According to an eighth aspect of the present invention, in the member coupling method of the first aspect, each of the first and second members is provided with an optical element; and the optical element is used to judge optically whether the positioning between the first and second members is good or not.

Accordingly, also in the case where members provided with optical elements requiring strict positioning accuracy are to be bonded to each other, low-cost and high-reliable coupling can be performed.

According to a ninth aspect of the present invention in the member coupling method of the first aspect, which comprises the steps of:

preparing the first member having a first optical element and cylindrical body, and the second member having a second optical element;

applying the first adhesive agent able to be cured by light inner surface of the cylindrical body of the first member or outer surface of the second member;

applying the second adhesive agent to the first member or the second member so that a light can reach that;

performing positioning between the first and second optical elements;

first bonding by irradiating so as to reach a light to the first adhesive agent; and

second bonding for curing the second adhesive agent.

Accordingly, at the part where light can be reach easily, two members are temporarily fixed to each other by the first adhesive agent, and then inner surface of the cylindrical body are fixed to outer surface of the second member strongly. For example, with respect to a part where light cannot be reach easily, the first and second members can be fixed each other by heat curing adhesive.

According to a tenth aspect of the present invention in the member coupling method of the first aspect, which comprises the steps of:

preparing the first member made of a light shielding cylindrical body having a first optical element therein, and the second member having a second optical element;

applying the second adhesive agent able to be cured by light to inner end surface of the cylindrical body of the first member or outer surface of an optical element to be fixed to the end of the cylindrical body;

applying the first adhesive agent to a flange portion of the optical element or the end surface of the casing;

first bonding by irradiating for curing the first adhesive agent; and

second bonding by heating treatment for curing the second adhesive agent.

Accordingly, at first, in outer portion where light can be reach easily, two members are temporarily fixed to each other by the first adhesive agent rapidly, and then inner portion where light cannot be reach easily are fixed strongly. Therefore quite accurate positioning can be performed. Further in the case optical characteristic is deteriorated by flowing into the casing provided with an optical, by using the method according to the tenth aspect, the first adhesive agent is stopped flowing by the second adhesive agent and reliable bonding can be performed.

According to a ninth aspect of the present invention, there is provided an optical part formed by coupling a first member provided with an optical element and a second member provided with another optical element and required to be positioned with the first member, comprising: a first adhesive bonding portion where the first and second members are bonded to each other by an adhesive agent cured by light; and a second adhesive bonding portion in-which the first and second members are bonded to each other by another adhesive agent cured by heat.

Accordingly, when the first adhesive bonding portion is used for temporary fixation, an optical part with little displacement between the two members can be obtained. Further, when the second adhesive bonding portion is used for fixing the two members to each other, a high-reliable optical part with a larger fixing force can be obtained.

According to a tenth aspect of the present invention, in the optical part of the ninth aspect, the first and second members are bonded to each other so that a predetermined space is formed; and the adhesive agent used in the second adhesive bonding portion is disposed so that the space is not invaded by an uncured component of the adhesive agent used in the first adhesive bonding portion.

Accordingly, even in the case where an uncured component remains in the adhesive agent used in the first adhesive bonding portion for temporary fixation, the adhesive agent used in the second adhesive bonding portion can prevent the uncured component from invading the space. Accordingly, this is particularly convenient to such an optical part in the case where it is undesirable that the uncured component invades the space.

### BRIEF DESCRIPTION OF THE DRAWINGS

FIG. 1 is a sectional view showing the configuration of a photo-coupler 20 which is an optical part according to an embodiment of the present invention;

FIG. 2A is a perspective view showing the external appearance of the casing 22;

FIG. 2B is a perspective view showing the external appearance of the laser diode 24;

FIG. 3 is a sectional view for explaining a method of producing a photo-coupler 40 according to another embodiment of the present invention;

FIG. 4 is a sectional view for explaining the method of producing the photo-coupler 40 according to the other embodiment of the present invention;

FIGS. 5A and 5B are views for explaining an example of a background-art method of producing a photo-coupler;

FIGS. 6A and 6B are views for explaining another example of the background-art method of producing a photo-coupler; and

FIGS. 7A and 7B are views for explaining a further example of the background-art method of producing a photo-coupler.

### DESCRIPTION OF THE PREFERRED EMBODIMENTS

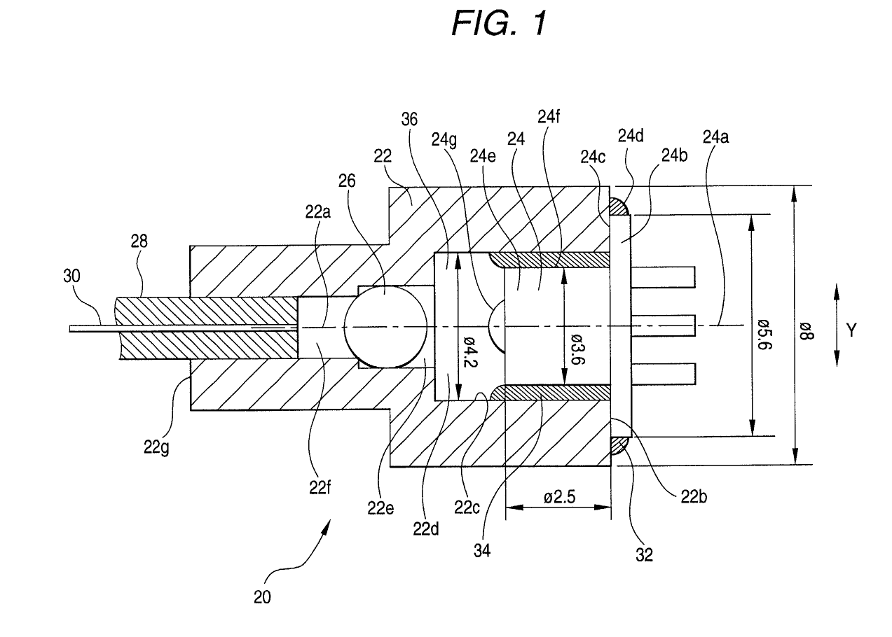

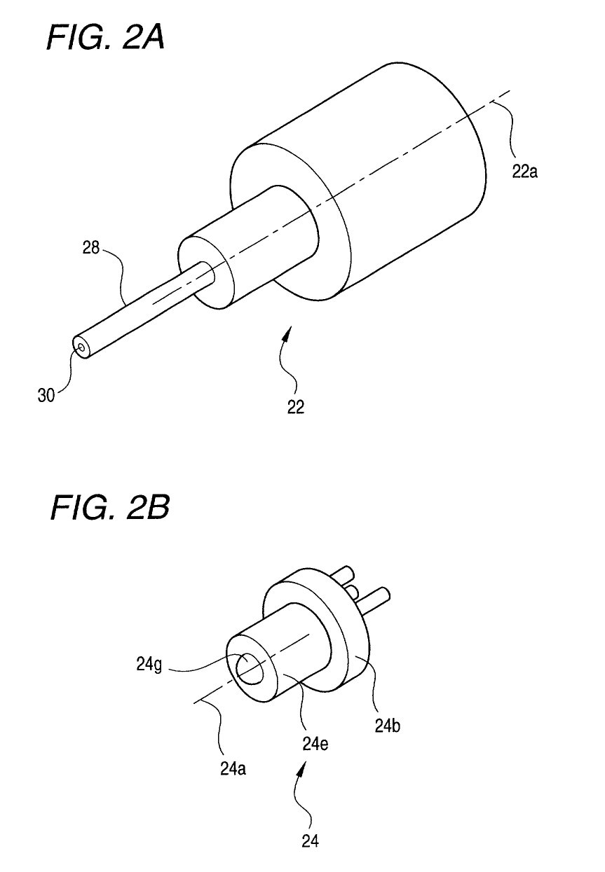

FIG. 1 is a sectional view showing the configuration of a photo-coupler 20 which is an optical part according to an embodiment of the present invention. The photo-coupler 20 is formed by fitting and adhesively bonding a laser diode 24 (optical element) as a second member shown in FIG. 2B into a suitable portion of a casing 22 as a first member shown in FIG. 2A.

As shown in FIG. 1, the casing 22 is made of nickel-plated iron or stainless steel and externally shaped like a stepped cylinder. In the inside of the casing 22, three cylindrical spaces 22d, 22e and 22f which communicate with one another are formed in the order named. The cylindrical space 22d opens to one end surface 22b of the casing 22. The cylindrical space 22f opens to the other end surface 22g of the casing 22. In descending order of inner diameter, the cylindrical space 22d, 22e and 22f are provided. That is, the cylindrical space 22d has the largest inner diameter.

An optical fiber 30 which is an optical element is held through a ceramic ferrule 28 in the cylindrical space 22f having the smallest inner diameter. A ball lens 26 which is an optical element is held in the cylindrical space 22e having the intermediate inner diameter. The casing 22 is set so that the center axis of the optical fiber 30 passes substantially through the center of the ball lens 26. This axis is referred to as the optical axis of the casing 22″. The laser diode 24 is held in the cylindrical space 22d having the largest inner diameter.

The laser diode 24 has a cap portion 24e, and a flange 24b following the cap portion 24e. An external portion of the cap portion 24e is made of steel. A laser diode chip (not shown) is disposed in the inside of the cap portion 24e. The flange 24b is made of steel or copper alloy plated with gold (Au).

Laser light emitted from the laser diode chip is radiated through a ball lens 24g provided in the tip center of the cap portion 24e. The optical axis of the radiated laser light is referred to as “the optical axis 24a of the laser diode 24”.

The laser diode 24 is arranged so that not only the cap portion 24e enters the cylindrical space 22d of the casing 22 but also one end surface 24c of the flange 24b abuts on one end surface 22b of the casing 22. In this state, the laser diode 24 is fixed to the casing 22 by the first and second adhesive agents 32 and 34 which are first and second adhesive agents respectively.

The optical axis 22a of the casing 22 and the optical axis 24a of the laser diode 24 are adjusted so as to coincide with each other. Accordingly, the laser light emitted from the laser diode chip of the laser diode 24 is transmitted to another device (not shown) through the ball lens 24g of the laser diode 24, the ball lens 26 and the optical fiber 30.

The first adhesive agent 32 is of an ultraviolet-curable epoxy type. The first adhesive agent 32 is arranged so that a cylindrical outer circumferential surface 24d of the flange 24b of the laser diode 24 is adhesively bonded to one end surface 22b of the casing 22 by the first adhesive agent 32. The portions subjected to adhesive bonding by the first adhesive agent 32 are referred to as “first adhesive bonding portion”.

On the other hand, the second adhesive agent 34 is of a heat-curable epoxy type. The second adhesive agent 34 is arranged so that a gap between a cylindrical inner circumferential surface 22c of the cylindrical space 22d of the casing 22 and a cylindrical outer circumferential surface 24f of the cap portion 24e of the laser diode 24 is filled with the second adhesive agent 34. The cylindrical inner circumferential surface 22c and the cylindrical outer circumferential surface 24f subjected to adhesive bonding by the second adhesive agent 34 are referred to as “second adhesive bonding portion”.

A portion (hollow portion 36) which remains as a hollow in the cylindrical spaces 22d, 22e and 22f of the casing 22, is referred to as “predetermined space”. The ball lens 24g of the laser diode 24, the ball lens 26 and an end surface of the optical fiber 30 are exposed in the hollow portion 36.

The adhesive agent 34 which is arranged so that the gap between the cylindrical inner circumferential surface 22c and the cylindrical outer circumferential surface 24f is filled with the second adhesive agent 34, prevents an uncured component of the first adhesive agent 32 from invading the hollow portion 36. Incidentally, for reference, the dimensions of respective portions of the photo-coupler 20 are shown in FIG. 1.

Referring to FIG. 1, a method of producing the photo-coupler 20 will be described below. First, the casing 22 (see FIG. 2A), in which the optical fiber 30 held in the ferrule 28 and the ball lens 26 are fixed, and the laser diode 24 (see FIG. 2B) are prepared.

Then, the heat-curable epoxy type adhesive agent 34 is applied onto either or both of the cylindrical outer circumferential surface 24f of the cap portion 24e of the laser diode 24 and the cylindrical inner circumferential surface 22c of the cylindrical space 22d of the casing 22. In this embodiment, the adhesive agent 34 is of a two-liquid combination type epoxy resin adhesive agent, known as EPO-TEK OG115-3. The adhesive agent 34 is applied onto the adhesive bonding portion so that the thickness of the coated adhesive agent is 0.1 mm, after a main agent and a curing agent as two liquid components of the second adhesive agent 34 are mixed with each other.

Then, the cap portion 24e of the laser diode 24 is inserted in the cylindrical space 22d of the casing 22d so that one end surface 24c of the flange 24b of the laser diode 24 abuts on one end surface 22b of the casing 22. In this state, the ultraviolet-curable epoxy type first adhesive agent 32 known as EPO-TEK354 is applied onto an exposed portion between the end surface 22b of the casing 22 and the cylindrical outer circumferential surface 24d of the flange 24b of the laser diode 24.

In this state, the laser diode 24 is moved relative to the casing 22 both in Y directions in FIG. 1 and in directions perpendicular to the paper surface of FIG. 1 so as to perform positioning to make the optical axis 24a of the laser diode 24 coincide with the optical axis 22a of the casing 22. The amount of laser light emitted from the laser diode 24 and reached a measurement device (not shown) connected to the other end of the optical fiber 30 is examined. As a result, judgment is made as to whether the optical axes of the two coincide with each other or not.

During the positioning, both the first and second adhesive agents 32 and 34 are fluid. Accordingly, resistance caused by the first and second adhesive agents 32 and 34 at the time of the movement of the laser diode 24 relative to the casing 22 is not so large.

Ultraviolet rays are radiated at the point of time when the optical axes of the two coincide with each other. By radiation of ultraviolet rays, the ultraviolet-curable first adhesive agent 32 applied onto the exposed portion between the end surface 22b of the casing 22 and the cylindrical outer circumferential surface 24d of the flange 24b of the laser diode 24 is cured so that the laser diode 24 is temporarily fixed to the casing 22. This is the first adhesive bonding treatment. In this state, the heat-curable second adhesive agent 34 has not been cured yet.

Incidentally, the curing time due to radiation of ultraviolet rays varies in accordance with the kind of the first adhesive agent 32, the amount of application of the first adhesive agent 32, amount of light etc. In this embodiment, the curing time is about 10 sec.

Then, the photo-coupler 20 in which the laser diode 24 is temporarily fixed to the casing 22 is heated. By heating, the heat-curable second adhesive agent 34 applied so that the gap between the cylindrical inner circumferential surface 22c of the cylindrical space 22d of the casing 22 and the cylindrical outer circumferential surface 24f of the cap portion 24e of the laser diode 24 is filled with the second adhesive agent 34 is cured so that the laser diode 24 is adhesively bonded to the casing 22 more firmly. This is the second adhesive bonding treatment.

Even in the case where an uncured component of the ultraviolet-curable first adhesive agent 32 enters a gap between the end surface 22b of the casing 22 and the end surface 24c of the flange 24b of the laser diode 24, the uncured component never invades the hollow portion 36 because the uncured component is cured by the action of the curing agent contained in the heat-curable second adhesive agent 34.

Incidentally, the curing condition for curing the second adhesive agent 34 varies in accordance with the kind of the first adhesive agent 32, the amount of application of the first adhesive agent 32, etc. In this embodiment, the curing condition is heating at a temperature of from 120° C. to 150° C. for 1 hour. As described above, the casing 22 and the laser diode 24 are bonded to each other to thereby produce the photo-coupler 20.

As described above, in this embodiment, after the casing 22 and the laser diode 24 are positioned with each other, the casing 22 and the laser diode 24 are bonded to each other by the ultraviolet-curable first adhesive agent 32 to make short-time fixation possible. Then, the casing 22 and the laser diode 24 are bonded to each other by the heat-curable second adhesive agent 34 requiring a longer fixing time than the ultraviolet-curable first adhesive agent 32.

Accordingly, when the casing 22 and the laser diode 24 are temporarily fixed to each other rapidly by use of the ultraviolet-curable first adhesive agent 32 after the positioning, the casing 22 and the laser diode 24 can be prevented from being displaced from each other after the positioning. Then, the casing 22 and the laser diode 24 thus temporarily fixed to each other can be fixed to each other more firmly in a sufficient long time by use of the heat-curable second adhesive agent 34. Accordingly, bonding with little displacement and high strength can be performed by use of the adhesive bonding treatments which are easy to work. That is, low-cost and high-reliable coupling can be performed. In the case, bonding can be performed with an accuracy not more than 0.2 μm.

Further, when an optimum adhesive agent is used in accordance with the purpose of each adhesive bonding treatment, the casing 22 and the laser diode 24 can be bonded to each other more efficiently.

Further, since the ultraviolet-curable first adhesive agent 32 is applied in advance before the positioning, temporary fixation can be performed more rapidly only by irradiation of ultraviolet rays onto the applied first adhesive agent 32 after the positioning.

Further, since the heat-curable second adhesive agent 34 is applied in advance before the positioning, the casing 22 and the laser diode 24 can be fixed to each other more easily and firmly only by heating the second adhesive agent 34 after the positioning and temporary fixation.

Further, since the heat-curable second adhesive agent 34 can be applied in advance before the positioning, the place where the second adhesive agent 34 cannot be applied after the positioning and temporary fixation can be subjected to adhesive bonding. Further, the adhesive-bonding portion is not limited within a range where light can reach as in the case where the adhesive agent is cured by light. Accordingly, the casing 22 and the laser diode 24 can be adhesively bonded to each other in any convenient place selected freely. Accordingly, the casing 22 and the laser diode 24 can be fixed to each other more firmly.

Further, in this embodiment, the casing 22 and the laser diode 24 are bonded to each other so that the hollow portion 36 is formed, and the heat-curable second adhesive agent 34 is disposed so that an uncured component of the ultraviolet-curable first adhesive agent 32 used for temporary fixation never invades the hollow portion 36.

Accordingly, even in the case where an uncured component remains in the ultraviolet-curable first adhesive agent 32 when temporary fixation is performed by use of the ultraviolet-curable first adhesive agent 32, the heat-curable second adhesive agent 34 which is disposed in a suitable place and cured sufficiently in a long time can prevent the uncured component from invading the hollow portion 36. Accordingly, there is no fear that the uncured component is prevented from being deposited on the ball lens 24g of the laser diode 24, the ball lens 26 and an end surface of the optical fiber 30 exposed in the hollow portion 36 so as to give influence on an optical system.

Further, in this embodiment, a two-liquid combination epoxy type adhesive agent is used as the heat-curable second adhesive agent 34. Accordingly, the uncured component (made of mainly epoxy resin) of the epoxy type ultraviolet-curable first adhesive agent 32 can be cured by a curing agent contained in the heat-curable second adhesive agent 34.

Accordingly, even in the case where an uncured component remains in the ultraviolet-curable first adhesive agent 32 at the time of temporary fixation, the uncured component can be cured by the curing agent contained in the heat-curable second adhesive agent 34 disposed in a suitable place. Accordingly, the uncured component of the first adhesive agent 32 can be more easily prevented from invading the hollow portion 36.

Further, in this embodiment, the casing 22 is provided with the optical fiber 30 and the ball lens 26 which are optical elements whereas the laser diode 24 is an optical element itself. Further, whether the positioning of the laser diode 24 with the casing 22 is good or not is judged by an optical method using the aforementioned optical elements.

Accordingly, in the case where the laser diode 24 is bonded to the casing 22 provided with optical elements requiring strict positioning accuracy, low-cost and high-reliable coupling can be performed.

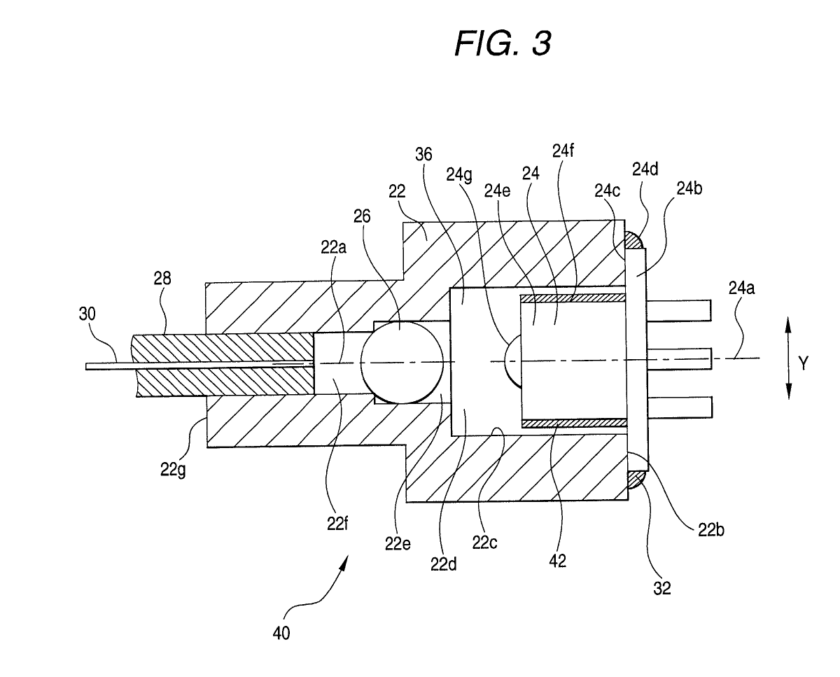

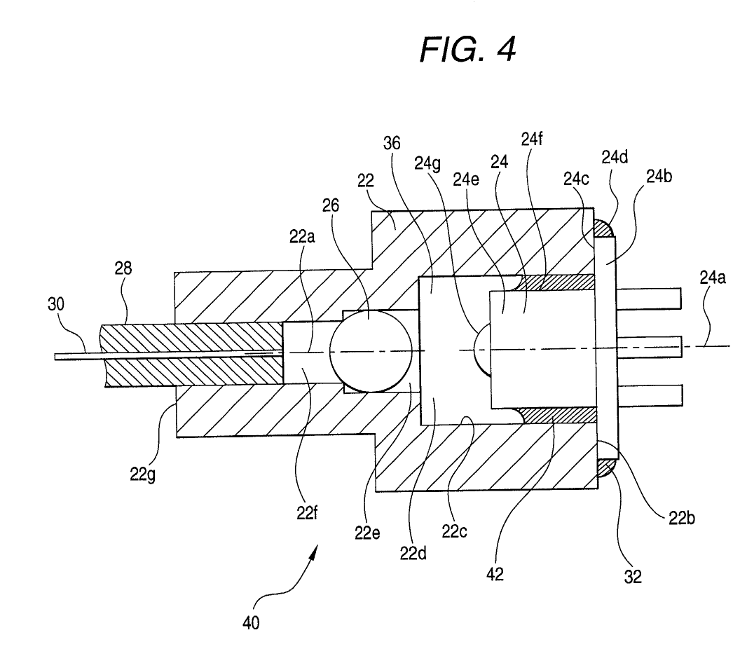

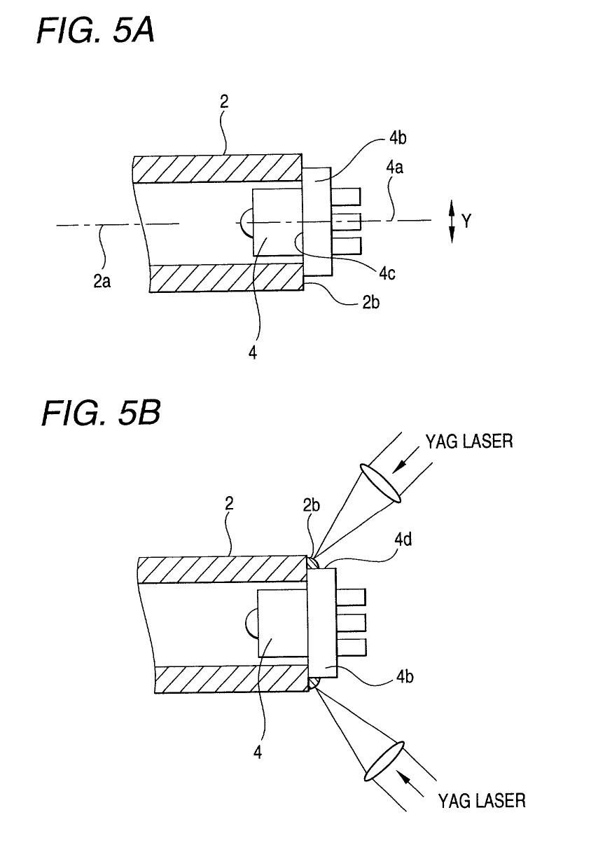

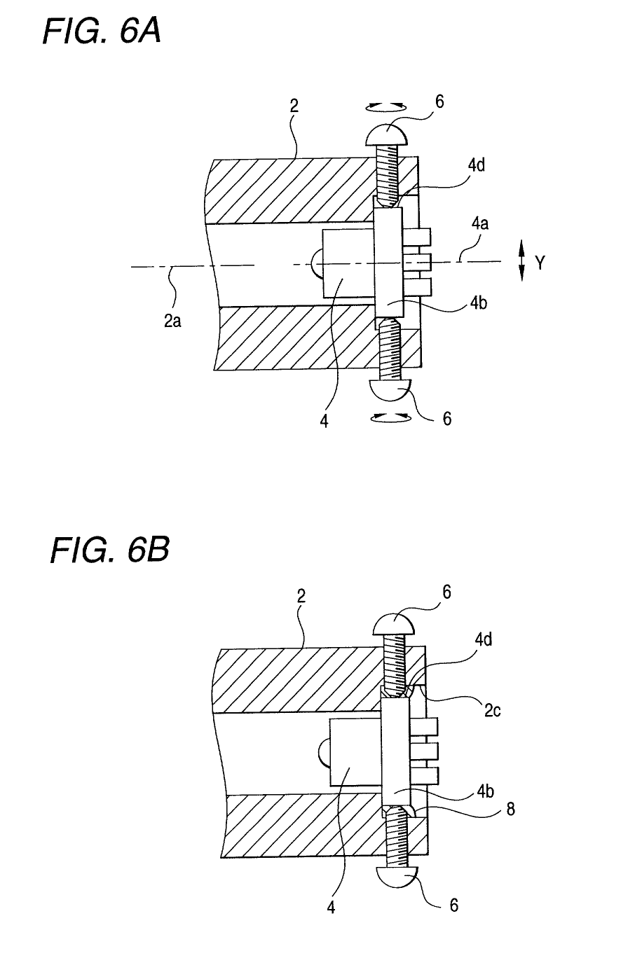

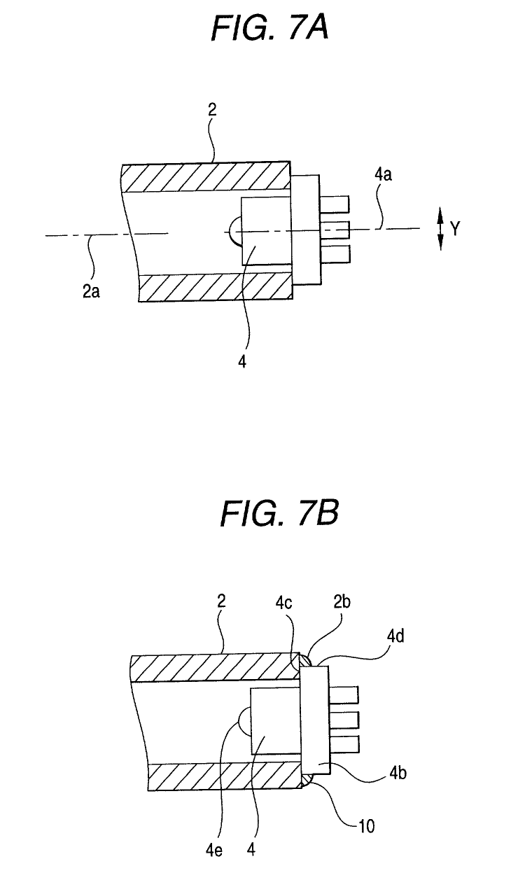

Although the aforementioned embodiment has shown the case where a two-liquid combination epoxy type heat-curable second adhesive agent 34 is used as the second adhesive agent, the second adhesive agent is not limited thereto. For example, a solid epoxy type adhesive agent (shaped like a ring or like a tape), or the like, can be used as the second adhesive agent. FIGS. 3 and 4 are views for explaining a method of producing a photo-coupler 40 by use of a solid epoxy type ring-like adhesive agent 42 as the second adhesive agent.

The method of producing the photo-coupler 40 shown in FIG. 4 is substantially the same as the method of producing the photo-coupler 20 shown in FIG. 1, except that the two-liquid combination epoxy type second adhesive agent 34 used as the second adhesive agent in FIG. 1 is replaced by the solid epoxy type adhesive agent 42 in FIG. 4 as described above.

That is, first, the casing 22 (see FIG. 2A) in which the optical fiber 30 held in the ferrule 28 and the ball lens 26 are fixed, and the laser diode 24 (see FIG. 2B) are prepared. The heat-curable epoxy type ring-like adhesive agent 42 is fitted onto the cylindrical outer circumferential surface 24f of the cap portion 24e of the laser diode 24.

After that, the same work as in the case of the photo-coupler 20 shown in FIG. 1 is carried out. The cap portion 24e of the laser diode 24 is inserted in the cylindrical space 22d of the casing 22. Then, the ultraviolet-curable epoxy type first adhesive agent 32 is applied. Then, the laser diode 24 is moved relative to the casing 22 both in Y directions in FIG. 3 and in directions perpendicular to the paper surface of FIG. 3, and positioning is carried out so that the optical axis 24a of the laser diode 24 coincide with the optical axis 22a of the casing 22.

As shown in FIG. 3, a gap enough to isolate the ring-like adhesive agent 42 and the casing 22 from each other at the time of the positioning is formed between the outer circumference of the ring-like adhesive agent 42 fitted onto the cylindrical outer circumferential surface 24f of the cap portion 24e of the laser diode 24 and the cylindrical inner circumferential surface 22c of the cylindrical space 22d of the casing 22. Accordingly, there is no resistance caused by the adhesive agent 42 at the time of the positioning.

The ring-like adhesive agent 42 fitted onto the cylindrical outer circumferential surface 24f of the cap portion 24e of the laser diode 24 is melted by heating after that and then it is cured. Consequently, as shown in FIG. 4, the gap between the cylindrical inner circumferential surface 22c of the cylindrical space 22d of the casing 22 and the cylindrical outer circumferential surface 24f of the cap portion 24e of the laser diode 24 is filled with the adhesive agent 42. In this manner, the casing 22 and the laser diode 24 are bonded to each other to thereby produce the photo-coupler 40.

As described above, in this embodiment, an epoxy type ring-like adhesive agent 42 which is not fluid before heating and which is once fluidized and then cured after heating, is used as the second adhesive agent.

Accordingly, if the above gap is kept sufficiently when the adhesive agent 42 is fitted onto the cylindrical outer circumferential surface 24f of the cap portion 24e of the laser diode 24 in advance before the positioning, resistance caused by the adhesive agent 42 at the time of the movement of the laser diode 24 relative to the casing 22 for the positioning can be eliminated. Accordingly, the positioning can be performed easily compared with the embodiment of FIG. 1 in which a fluid second adhesive agent 34 is applied in advance.

Although the aforementioned embodiments have shown the case where an epoxy type heat-curable adhesive agent is used as the heat-curable adhesive agent, another adhesive agent than the epoxy type heat-curable adhesive agent may be used as the heat-curable adhesive agent. Although the aforementioned embodiments have shown the case where a heat-curable adhesive agent is used as the second adhesive agent, the second adhesive agent is not limited to such a heat-curable adhesive agent. When, for example, light reaches the second adhesive bonding portion in the second adhesive bonding treatment, a light-curable adhesive agent may be used as the second adhesive agent.

Although the aforementioned embodiments have shown the case where an epoxy type ultraviolet-curable adhesive agent is used as the ultraviolet-curable adhesive agent, the ultraviolet-curable adhesive agent is not limited thereto. For example, an acrylic type ultraviolet-curable adhesive agent may be used as the ultraviolet-curable adhesive agent. Further, the light-curable adhesive agent is not limited to such an ultraviolet-curable adhesive agent. For example, an adhesive agent capable of being cured by visible light rays may be used as the light-curable adhesive agent.

Although the aforementioned embodiments have shown the case where a light-curable adhesive agent is used as the first adhesive agent, the first adhesive agent is not limited thereto. For example, a heat-curable adhesive agent, or the like, may be used as the first adhesive agent if the adhesive agent has a sufficiently high curing rate. Heat-curable adhesive agent can be used as both of the first and second adhesive agent, one of which have a different curing time from other, for example EPO-TEK 307 can be used as the first adhesive agent, and EPO-TEK 354 can be used as the second adhesive agent.

Although the aforementioned embodiments have shown the case where a closed space such as the hollow portion 36 is exemplified as the predetermined space formed by bonding the first and second members to each other, the predetermined space is not limited thereto. For example, an opened space may be contained in the predetermined space. Further, the present invention can be applied also to the case where no predetermined space is formed by bonding the first and second members to each other.

Although the aforementioned embodiments have shown the case where the second adhesive agent used in the second adhesive bonding treatment is arranged between the space and the first adhesive agent so that the uncured component of the first adhesive agent used in the first adhesive bonding treatment never invades the predetermined space, the arrangement of the adhesive agent used in the second adhesive bonding treatment is not limited to the aforementioned arrangement.

Although the aforementioned embodiments have shown the case where the first and second adhesive agents different from each other are used in the first and second adhesive bonding treatments respectively, the present invention is not limited thereto. One and the same adhesive agent may be used both in the first and second adhesive bonding treatments.

For example, an adhesive agent both of a light-curable type and of a heat-curable type may be applied onto the first and second adhesive bonding portions so that the adhesive agent applied onto the first adhesive bonding portion within a range where light can reach is selectively cured by irradiation of light in the first adhesive bonding treatment whereas the adhesive agent applied onto the second adhesive bonding portion where light does not reach is cured by heating in the second adhesive bonding treatment.

When one and the same adhesive agent is used both in the first and second adhesive bonding treatments, the adhesive agent applied onto one and the same place may be subjected to the first and second adhesive bonding treatments. For example, an adhesive agent both light-curable and heat-curable may be applied onto one adhesive bonding portion within a range where light can reach so as to be cured to some degree by irradiation of light in the first adhesive bonding treatment for the purpose of temporary fixation and then further cured by heating in the second adhesive bonding treatment. Further by setting a heating temperature in the second adhesive bonding treatment so as to be higher than that in the first adhesive bonding treatment, two step adhesive bonding treatment consist of temporary bonding treatment and main bonding treatment can be performed.

Although the aforementioned embodiments have shown the case where whether the positioning of the first and second members is good or bad is judged by an optical method using optical elements, the present invention can be applied also to the case where whether the positioning between the first and second members is good or not is judged by another method than an optical method using optical elements, for example, by eye observation.

Although the aforementioned embodiments have shown the case where a device formed by bonding of a laser diode to a member having an optical fiber is exemplified as the photo-coupler, the photo-coupler is not limited thereto. The present invention can be applied also to another photo-coupler, such as a device formed by coupling another light-emitting element than the laser diode with a member having an optical fiber, a device formed by coupling a light-receiving element such as a photo-transistor, or the like, with a member having an optical fiber, a device formed by coupling a module provided with both a light-receiving element and a light-emitting element with a member having an optical fiber, a device formed by coupling a light-receiving element with a light-emitting element, a device formed by coupling members each having an optical fiber with each other, and so on.

Although the aforementioned embodiments have shown the case where a photo-coupler is exemplified as the optical part, the present invention is not limited thereto. The present invention can be applied also to another optical part than the photo-coupler. Further, the present invention is not limited to optical parts but can be generally applied to techniques of coupling first and second members after positioning the first and second members with each other.

What is claimed is:

1. A method of coupling a first member and a second member with each other, comprising the steps of:
performing positioning between said first and second members;
first bonding said first and second members to each other by a first adhesive bonding treatment using a first adhesive agent to make short-time fixation possible; and
second bonding said first and second members to each other by a second adhesive bonding treatment using a second adhesive agent requiring a longer fixation time than that required for said first adhesive bonding treatment.

2. A method of coupling members according to claim 1, wherein
the second adhesive agent has a lower curing rate than that of said first adhesive agent and
the positioning is performed after applying the first and second adhesive agents to first region and second regions on the first and/or second member respectively,
and the first and second bonding steps are performed successively.

3. A method of coupling members according to claim 1, wherein said first adhesive bonding treatment is a treatment of curing an adhesive agent by light.

4. A method of coupling members according to claim 1, wherein said second adhesive bonding treatment is a treatment of curing an adhesive agent by heat.

5. A method of coupling members according to claim 4, wherein said second adhesive agent used in said second adhesive bonding treatment is an adhesive agent which is not fluid before heating and which is once fluidized and then cured by heating.

6. A method of coupling members according to claim 4, wherein:
said first and second members are bonded to each other so that a predetermined space is formed; and
said second adhesive agent used in said second adhesive bonding treatment is disposed between the space and the first adhesive agent so that said space is not invaded by an uncured component of said adhesive agent used in said first adhesive bonding treatment.

7. A method of coupling members according to claim 6, wherein said second adhesive agent used in said second adhesive bonding treatment is an adhesive agent containing a component for curing said uncured component of said first adhesive agent used in said first adhesive bonding treatment.

8. A method of coupling members according to claims 1, wherein:
each of said first and second members is provided with an optical element; and
the method further comprises a step of judging optically whether the positioning between said first and second members is good or not by using said optical element.

9. A method of coupling members according to claims 1, comprising the steps of:
preparing the first member having a first optical element and cylindrical body, and the second member having a second optical element;
applying the first adhesive agent able to be cured by light inner surface of the cylindrical body of the first member or outer surface of the second member;
applying the second adhesive agent to the first member or the second member so that a light can reach that;
performing positioning between the first and second optical elements;
first bonding by irradiating so as to reach a light to the first adhesive agent; and
second bonding for curing the second adhesive agent.

10. A method of coupling members according to claims 1, comprising the steps of:
preparing the first member made of a light shielding cylindrical body having a first optical element therein, and the second member having a second optical element;
applying the second adhesive agent able to be cured by light to inner end surface of the cylindrical body of the first member or outer surface of an optical element to be fixed to the end of the cylindrical body;
applying the first adhesive agent to a flange portion of the optical element or the end surface of the casing;
first bonding by irradiating for curing the first adhesive agent; and
second bonding by heating treatment for curing the second adhesive agent.

11. An optical part formed by coupling a first member provided with a first optical element and a second member provided with a second optical element and required to be positioned with said first member, comprising:
a first adhesive bonding portion where said first and second members are bonded to each other by the first adhesive agent cured by light; and
a second adhesive bonding portion in which said first and second members are bonded to each other by the second adhesive agent cured by heat.

12. An optical part according to claim 11, wherein:
said first and second members are bonded to each other so that a predetermined space is formed; and
said adhesive agent used in said second adhesive bonding portion is disposed so that said space is not invaded by an uncured component of said adhesive agent used in said first adhesive bonding portion.
